(19) United States
(12) Patent Application Publication
(10) Pub. No.: US 2012/0171072 A1
(43) Pub. Date: Jul. 5, 2012

(54) NANOWIRE PREPARATION METHODS, COMPOSITIONS, AND ARTICLES

(76) Inventors: Doreen C. Lynch, Afton, MN (US); Junping Zhang, Saint Paul, MN (US)

(21) Appl. No.: 13/314,232

(22) Filed: Dec. 8, 2011

Related U.S. Application Data
(60) Provisional application No. 61/429,853, filed on Jan. 5, 2011.

(51) Int. Cl. C22C 5/06; B22F 9/16; B82Y 40/00; B82Y 30/00

(52) U.S. Cl. 420/501; 75/343; 977/896; 977/762

(57) ABSTRACT

Methods of preparing nanowires, and compositions and articles comprising the nanowires are disclosed. Such methods allow tailored synthesis of nanowires based on one or more product geometrical parameters. Such tailored nanowires are useful in electronic applications.

### CROSS REFERENCE TO RELATED APPLICATIONS

This application claims the benefit of U.S. Provisional Application No. 61/429,853, filed Jan. 5, 2011, entitled NANOWIRE PREPARATION METHODS, COMPOSITIONS, AND ARTICLES, which is hereby incorporated by reference in its entirety.

### SUMMARY

At least some embodiments provide a method comprising providing at least one first composition comprising at least one first reducible metal ion, and reducing the at least one first reducible metal ion to at least one first metal in the presence of at least one second metal or metal ion differing in atomic number from the first reducible metal ion, at least one first protecting agent, at least one first solvent, and at least one second composition comprising seed particles, where at least about 75 number percent of the seed particles are multiply-twinned. In at least some embodiments, the at least one first reducible metal ion comprises at least one coinage metal ion, or at least one ion from IUPAC Group 11, or at least one ion of silver. In some cases, the at least one first compound comprises silver nitrate. The at least one second metal or metal ion may, for example, comprise at least one element from IUPAC Group 8, or it may, for example, comprise iron or an ion of iron. In at least some embodiments, the at least one first protecting agent comprises at least one of one or more surfactants, one or more acids, or one or more polar solvents, or it may, for example, comprise polyvinylpyrrolidinone. In at least some cases, the at least one first solvent comprises at least one polyol, such as, for example, one or more of ethylene glycol, propylene glycol, glycerol, one or more sugars, or one or more carbohydrates. In at least some embodiments, the composition has a ratio of the total moles of the at least one second metal or metal ion to the moles of the at least one first reducible metal ion from about 0.0001 to about 0.1. The reduction may be carried out at one or more temperatures, such as, for example, from about 120° C. to about 190° C. In at least some embodiments, the second composition comprises at least one coinage metal or coinage metal ion, or at least one element from IUPAC Group 11, such as, for example, silver or an ion of silver.

At least some embodiments provide such methods, where the seed particles are formed by a method comprising providing at least one third metal ion and contacting the at least one third metal ion with at least one second protecting agent and at least one second solvent.

Other embodiments provide the first metal product formed by any of these methods. Such a product may, for example, comprise one or more of nanowires, nanocubes, nanorods, nanopyramids, or nanotubes. Such nanowires may have an average diameter of about 50 to about 150 nm, or from about 50 to about 110 nm, or from about 80 to about 100 nm. Some embodiments provide one or more articles comprising at least one such nanowire. Such articles may, for example, comprise electronic devices.

Yet other embodiments provide a method comprising selecting at least one product geometrical parameter, providing at least one first composition comprising a first amount of at least one first reducible metal ion, providing at least one second composition comprising a second amount of the at least one first metal or metal ion, and reducing at least some of the first amount of the at least one first reducible metal ion to at least one first metal in the presence of the second amount of the at least one first metal or metal ion, where the ratio of the second amount to the first amount is specified based upon the at least one product geometrical parameter. The at least one product geometrical parameter may, for example, comprise one or more of a length, a diameter, a volume, or a surface area. In at least some embodiments, the ratio of the second amount to the first amount may be selected to be a function of a product length, or to be a function of a product length multiplied by a product diameter, or to be a function of a product length multiplied by the square of a product diameter, or to be a function of a product volume, or to be a function of the three-half power of a product surface area. Such functions may be linear functions, such as, for example, a direct proportionality, or they may be non-linear functions. In at least some embodiments, the at least one first reducible metal ion comprises a coinage metal ion, an ion from IUPAC Group 11, or a silver ion. Some embodiments provide at least one nanowire comprising the at least one first metal product formed by such methods. Other embodiments provide articles comprising such first metal products, such as electronic devices.

These and other embodiments may be understood from the brief description of figures, figures, description, exemplary embodiments, examples, and claims that follow.

### BRIEF DESCRIPTION OF FIGURES

FIG. 1 shows a transmission electron micrograph of silver seed particles produced according to an embodiment of the invention.

FIG. 2 shows a transmission electron micrograph of silver seed particles produced according to an embodiment of the invention.

FIG. 3 shows an optical micrograph of nanowires produced according to an embodiment of the invention.

FIG. 4 shows a scanning electron micrograph of nanowires produced according to an embodiment of the invention.

### DESCRIPTION

All publications, patents, and patent documents referred to in this document are incorporated by reference herein in there entirety, as though individually incorporated by reference.

U.S. Provisional Application No. 61/429,853, filed Jan. 5, 2011, entitled NANOWIRE PREPARATION METHODS, COMPOSITIONS, AND ARTICLES, is hereby incorporated by reference in its entirety.

Silver nanowires (AgNW) are a unique and useful wire-like form of the metal in which the two short dimensions (the thickness dimensions) are less than 300 nm, while the third dimension (the length dimension) is greater than 1 micron, preferably greater than 10 microns, and the aspect ratio (ratio of the length dimension to the larger of the two thickness dimensions) is greater than five. They are being examined as conductors in electronic devices or as elements in optical devices, among other possible uses.

A number of procedures have been presented for the preparation of AgNW. See, for example, Y. Xia, et al. (Angew. Chem. Int. Ed. 2009, 48, 60), which is hereby incorporated by reference in its entirety. These include the “polyol” process, in which a silver salt is heated in a polyol (typically ethylene glycol (EG)) in the presence of polyvinylpyrrolidone (PVP), yielding a suspension of AgNW in EG, from which the wires can be isolated and/or purified as desired.

While small scale preparations of AgNW have been reported, repetition of these procedures is often difficult and scaling up these procedures to produce larger quantities of wires (as needed for some of the envisioned applications) typically results in inferior material.

Among the traits of this inferior material are: higher levels of metal particles with an aspect ratio below five (non-wire-shaped particles herein referred to simply as particles), AgNW which are shorter on average than desired, and AgNW which are thicker on average than desired. A scalable process is clearly desirable.

H. Takada describes in U.S. Patent application 2009/0130433 a process for preparing metal nanowires by forming a nucleus metal particle.

Y. Sun, B. Mayers, T. Herricks, and Y. Xia (Nano Letters, 2003, 3(7), 955-960), hereby incorporated by reference in its entirety, proposed that AgNW are the result of the growth of multiply-twinned particles (MTP) of silver metal.

P.-Y. Silvert et al. (J. Mater. Chem., 1996, 6(4), 573-577 and J. Mater. Chem., 1997, 7, 293-299, both of which are hereby incorporated by reference in their entirety), described the formation of colloidal silver dispersions in EG in the presence of PVP. Chen et al. (Nanotechnology, 2006, 17, 466-74), hereby incorporated by reference in its entirety, described effects of changing seed concentrations on morphology.

Applicants have recognized that colloidal silver dispersions, prepared, for example, by the procedures of Silvert et al. are excellent “templates or seeds” from which to grow AgNW.

Silver “seeds” prepared by this method were isolated and characterized by transmission electron microscopy (TEM) and found to be predominately the expected MTP's. AgNW were then prepared by adding the seeds to hot ethylene glycol, followed simultaneously by solutions of silver nitrate and PVP in ethylene glycol. After holding the mixture at elevated temperature, a suspension of AgNW in ethylene glycol is obtained. The AgNW can be isolated, as desired, by standard methods, including centrifugation and filtration.

Previous AgNW preparations such as Takada employ an in situ approach to preparing seeds (the addition of silver nitrate to hot EG, just prior to the main addition of the silver nitrate and the PVP solutions), or they employ no separate seeding step at all. (See, for example, Y. Sun and Y. Xia, Adv. Mater. 2002, 14(11), 833-837, which is hereby incorporated by reference in its entirety).

While these previous methods may yield AgNW, their morphological purity is highly variable. High and/or variable levels of non-wire particles may also be formed, decreasing the yield of the desired nanowires and requiring additional purification steps.

Applicants have observed that this difficulty is exacerbated as the scale of the procedure is increased. In contrast, the addition of silver “seeds,” such as those described in this disclosure, results in AgNW preparations with reproducibly low levels of non-wire particles, even as the scale is increased.

One example of a process to prepare silver nanowires comprises: preparation of a colloidal silver dispersion in which said dispersed silver particles have a largest dimension preferably less than about 50 nm, more preferably less than about 25 nm, and more than 75 number % of said silver particles are multiply-twinned particles, adding said colloidal silver dispersion to a heated polyol under an inert atmosphere, followed by addition of a solution or solutions of a silver salt and polyvinylpyrrolidone in a polyol under conditions which grow nanowires from the colloidal silver dispersion particles, and holding the mixture at an elevated temperature to complete the nanowire growth. The polyol may be, for example, ethylene glycol or propylene glycol. The amount of silver in the colloidal silver dispersion may, for example, be between 0.001 and 1 mole % of the total silver. The silver salt is preferably silver nitrate. An iron salt may be added to the heated polyol. Such iron salts may, for example, include iron(II) chloride or iron acetonylacetate. A chloride salt may be added to the heated polyol. Such chloride salts may, for example, include iron(II) chloride or sodium chloride. The PVP and silver salt solutions may, in some embodiments, be added as separate solutions at substantially the same rate. The mole ratio of PVP to silver nitrate may, for example, be from about 1:1 to about 10:1. The reaction temperature may, for example, be from about 130° C. to about 170° C., or from about 135° C. to about 150° C. The reaction is preferably stirred throughout. The nanowires may be isolated or purified by, for example, centrifugation, removal of the supernatant, addition of solvent(s), and re-dispersion. The nanowires have an average diameter of from about 50 nm to about 150 nm, or from about 60 nm to about 110 nm, or from about 80 nm to about 100 nm.

Applicants have discovered that when performing nanowire synthesis using seed particles, the ratio of the amount of silver supplied during nanowire synthesis to the amount to be supplied in the seed particles may be selected to control various geometrical parameters of the product nanowires, for example, nanowire length, diameter, volume, surface area, and the like. That is, the ratio may be selected based on a function of one or more targeted geometrical parameters. In some embodiments, such a function may be a linear function, such as a direct proportionality, of one or more of the parameters, or the function may be a nonlinear function of one or more of the parameters. For example the ratio of the amount of silver supplied during nanowire synthesis to the amount supplied in the seed particles may be about 55.1 μm⁻¹ multiplied by the nanowire length in μm, or the ratio may be about 472 μm⁻² multiplied by the nanowire length in μm multiplied by the nanowire diameter in μm, or the ratio may be about 4010 μm⁻³ multiplied by the nanowire length in μm multiplied by the square of the nanowire diameter in μm².

### EXEMPLARY EMBODIMENTS

U.S. Provisional Application No. 61/429,853, filed Jan. 5, 2011, entitled NANOWIRE PREPARATION METHODS, COMPOSITIONS, AND ARTICLES, which is hereby incorporated by reference in its entirety, disclosed the following 30 exemplary embodiments:

A. A method comprising:

providing at least one first composition comprising at least one first reducible metal ion; and

reducing the at least one first reducible metal ion to at least one first metal in the presence of at least one second metal or metal ion differing in atomic number from the first reducible metal ion, at least one first protecting agent, at least one first solvent, and at least one second composition comprising seed particles,

wherein at least about 75 number percent of the seed particles are multiply-twinned.

B. The method of embodiment A, wherein the at least one first reducible metal ion comprises at least one coinage metal ion.
C. The method of embodiment A, wherein the at least one first reducible metal ion comprises at least one ion from IUPAC Group 11.
D. The method of embodiment A, wherein the at least one first reducible metal ion comprises at least one ion of silver.
E. The method of embodiment A, wherein the at least one first compound comprises silver nitrate.
F. The method of embodiment A, wherein the at least one second metal or metal ion comprises at least one element from IUPAC Group 8.
G. The method of embodiment A, wherein the at least one second metal or metal ion comprises iron or an ion of iron.
H. The method of embodiment A, wherein the at least one first protecting agent comprises at least one of: one or more surfactants, one or more acids, or one or more polar solvents.
J. The method of embodiment A, wherein the at least one first protecting agent comprises polyvinylpyrrolidinone.
K. The method of embodiment A, wherein the at least one first solvent comprises at least one polyol.
L. The method of embodiment A, wherein the at least one first solvent comprises at least one of: ethylene glycol, propylene glycol, glycerol, one or more sugars, or one or more carbohydrates.
M. The method of embodiment A, wherein the composition has a ratio of the total moles of the at least one second metal or metal ion to the moles of the at least one first reducible metal ion from about 0.0001 to about 0.1.
N. The method of embodiment A, wherein the reduction is carried out at one or more temperatures from about 120° C. to about 190° C.
P. The method of embodiment A, wherein the second composition comprises at least one coinage metal or coinage metal ion.
Q. The method of embodiment A, wherein the at least one second composition comprises at least one element from IUPAC Group 11.
R. The method of embodiment A, wherein the at least one second composition comprises silver or an ion of silver.
S. At least one first metal product formed by the method of embodiment A.
T. The product according to embodiment S, comprising one or more of nanowires, nanocubes, nanorods, nanopyramids, or nanotubes.
U. The product according to embodiment S, comprising at least one nanowire.
V. At least one article comprising at least one nanowire of embodiment U.
W. The method of embodiment A, wherein the seed particles are formed by a method comprising:

providing at least one third metal ion; and

contacting said at least one third metal ion with at least one second protecting agent and at least one second solvent.

X. A method comprising:

selecting at least one product geometrical parameter;

providing at least one first composition comprising a first amount of at least one first reducible metal ion;

providing at least one second composition comprising a second amount of at least one second metal or metal ion; and

reducing at least some of the first amount of the at least one first reducible metal to at least one first metal in the presence of the second amount of the at least one second metal or metal ion,

wherein the ratio of the second amount to the first amount is specified based upon the at least one product geometrical parameter.

Y. The method according to embodiment X, wherein the at least one product geometrical parameter comprises one or more of a length, a diameter, a volume, or a surface area.
Z. The method according to embodiment X, wherein the ratio of the second amount to the first amount is selected to be a function of a product length.
AA. The method according to embodiment X, wherein the ratio of the second amount to the first amount is selected to be a function of a product length multiplied by the square of a product diameter.
AB. The method according to embodiment X, wherein the ratio of the second amount to the first amount is selected to be a function of a product volume.
AC. The method according to embodiment X, wherein the ratio of the second amount to the first amount is selected to be a function of the three-half power of a product surface area.
AD. The method according to embodiment X, wherein the at least one first reducible metal ion comprises a silver ion.
AE. The method according to embodiment X, wherein the at least one first reducible metal ion comprises a first element and the at least one second metal or metal ion comprises a second element, the first element being the same as the second element.
AF. At least one first metal product formed according to the method of embodiment X.
AG. An article comprising the at least one first metal product of embodiment AF.

### EXAMPLES

### Example 1

### Preparation of Silver Seeds

Silver seeds were prepared similarly to the process of Silvert (P.-Y. Silvert et al., J. Mater. Chem., 1996, 6(4), 573-577, Experiment 1). Thus, to a solution of 12.0 g of polyvinylpyrrolidone (PVP) (55,000 molecular weight) in 150 mL of ethylene glycol (EG), was added 198.7 mg silver nitrate. The mixture was stirred 12 min at 22° C., then the temperature was ramped at a rate of 1° C./min to 115° C. The mixture was then held at 115° C. for between 10 minutes and 2 hours to yield the silver seed solution.

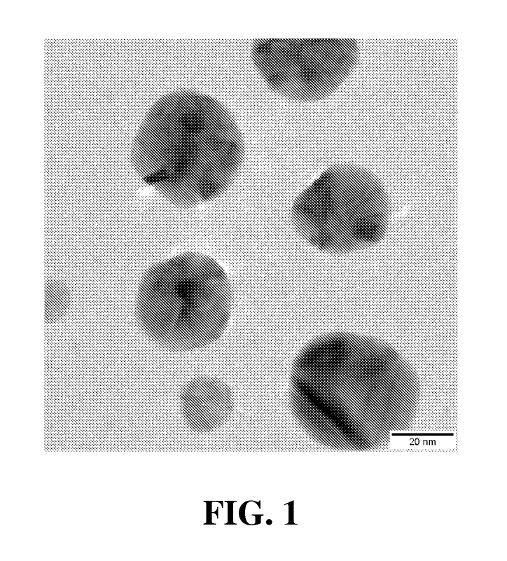

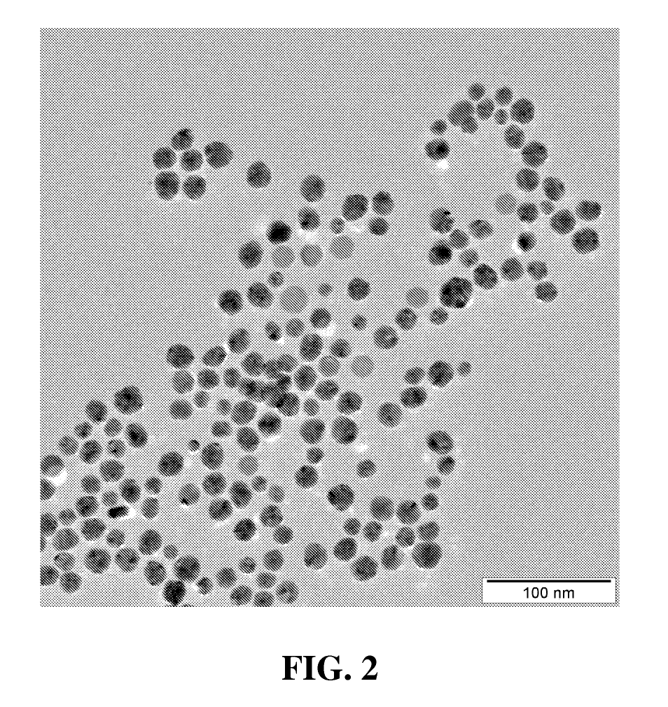

For characterization, 11.47 g of the silver seed solution was diluted with 28.3 g of acetone, and centrifuged at 2548 rpm for 8 min. The supernatant was decanted and discarded, then isopropanol added to the residue, which was redispersed by immersion in an ultrasonic bath for 5 min. An evaporated droplet of this dispersion was examined by transmission electron microscopy (TEM), as shown in FIGS. 1 and 2. Spheroidal particles with multiple twin planes were observed. The average particle diameter was 23.6+/−9.3 nm.

### Examples 2 through 6

### Preparation of Nanowires

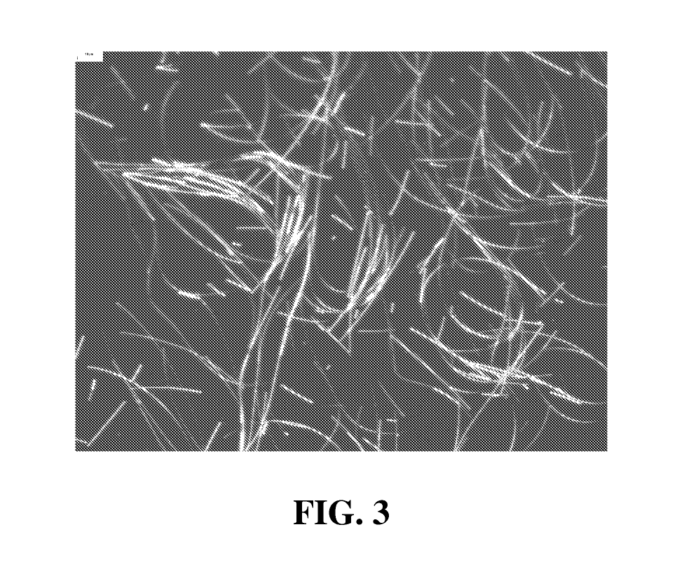

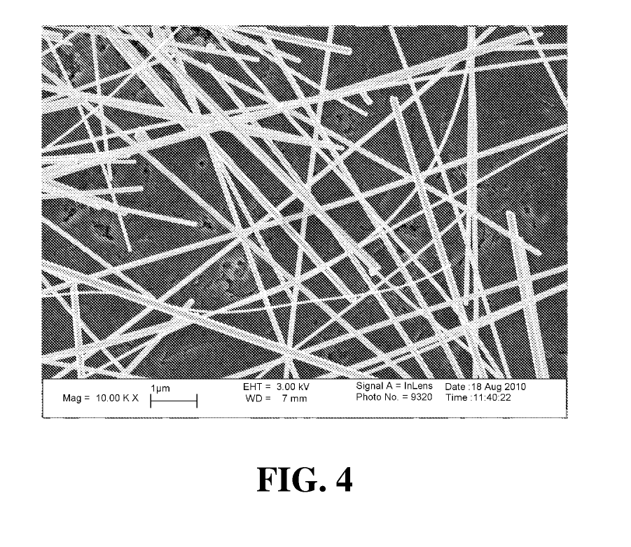

A 500 mL reaction vessel was charged with 280 mL EG and 1.28 mL of 6 mM FeCl₂ in EG. The solution was stripped of at least some dissolved gases by bubbling N₂ into the solution for at least 2 hrs using a glass pipette at room temperature with mechanical stirring while at 100 rpm. (This operation will be referred to as “degassing” in the sequel.) Meanwhile, a 0.846 M solution of PVP in EG, and a 0.282 M solution of AgNO₃ in EG were degassed with N₂. The reaction mixture was heated to 145° C. with continued N₂ bubbling for 60 min, then the N₂ bubbler was replaced with a regular N₂ inlet at top of condenser, to provide blanketing, and mechanical stirring begun. Then the silver seed solution of Example 1 was added, according to the amounts shown in Table I, followed immediately by addition of 20 mL each of the AgNO₃ and PVP solutions, which were added at a constant rate over 25-50 min, as shown in Table I, using a dual syringe pump. The reaction mixture was held at 145° C. for 60-90 min, as shown in Table I, and then cooled in an ice bath. The resulting solutions were examined using optical microscopy and scanning electron microscopy (SEM), as shown in FIGS. 3 and 4, respectively, for Example 2. Table I summarizes the diameter (by SEM) and length (by optical microscopy) of the nanowire product.

### Example 7

### Silver Feed Ratio from Targeted Product Length

The ratios of the amount of silver to be supplied during nanowire synthesis to the amount to be supplied in the seed solution were calculated from targeted nanowire lengths, based on the equation:

Ratio=55.1 μm⁻¹·(Nanowire Length, μm) (1)

This ratio was calculated for several different targeted wire lengths. Table II compares the ratio based on Eqn. (1) to the ratios experimentally determined in Examples 2-6 to achieve the targeted nanowire lengths.

### Example 8

### Silver Feed Ratio from Targeted Product Length and Diameter

The ratios of the amount of silver to be supplied during nanowire synthesis to the amount to be supplied in the seed solution were calculated from targeted nanowire lengths and diameters, based on the equation:

Ratio=4010 μm⁻³·(Nanowire Length, μm)

·(Nanowire Diameter, μm)² (2)

This ratio was calculated for several different targeted wire lengths and diameters. Table III compares the ratio based on Eqn. (2) to the ratios experimentally determined in Examples 2-6 to achieve the targeted nanowire lengths and diameters.

### Example 9

### Silver Feed Ratio from Targeted Product Length and Diameter

The ratios of the amount of silver to be supplied during nanowire synthesis to the amount to be supplied in the seed solution were calculated from targeted nanowire lengths and diameters, based on the equation:

Ratio=472 μm⁻²·(Nanowire Length, μm)

·(Nanowire Diameter, μm) (3)

This ratio was calculated for several different targeted wire lengths and diameters. Table IV compares the ratio based on Eqn. (3) to the ratios experimentally determined in Examples 2-6 to achieve the targeted nanowire lengths and diameters.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended embodiments, and all changes that come within the meaning and range of equivalents thereof are intended to be embraced therein.

TABLE I

| | | Time | Hold Time | | |
|---|---|---|---|---|---|
| | Seed | Interval for | After | | Mean |
| | Solution | Reagent | Reagent | Wire | Wire |
| | Added | Addition | Addition | Diameter | Length |
| Example | (mL) | (min) | (min) | (nm) | (μm) |
| 2 | 0.73 | 50 | 62 | 126 ± 35 | 14.0 ± 12.0 |
| 3 | 0.73 | 25 | 90 | 119 ± 44 | 19.1 ± 18.1 |
| 4 | 7.30 | 25 | 90 | 92 ± 28 | 4.0 ± 2.2 |
| 5 | 3.65 | 25 | 90 | 107 ± 30 | 6.8 ± 4.0 |
| 6 | 1.83 | 25 | 90 | 110 ± 38 | 11.5 ± 9.0 |

TABLE II

| | | Silver Feed Ratio |
|---|---|---|
| Targeted Wire | Silver Feed Ratio | Experimentally |
| Length | According to | Determined to Achieve |
| (μm) | Eqn. (1) | Targeted Length |
| 14 | 770 | 1054 |
| 19.1 | 1050 | 1054 |
| 4.0 | 220 | 105 |
| 6.8 | 374 | 211 |
| 11.5 | 632 | 421 |

TABLE III

| | | | Silver Feed Ratio |
|---|---|---|---|
| Targeted | Targeted | | Experimentally |
| Wire | Wire | Silver Feed Ratio | Determined to |
| Length | Diameter | According to | Achieve Targeted |
| (μm) | (nm) | Eqn. (2) | Length and Diameter |
| 14 | 126 | 891 | 1054 |
| 19.1 | 119 | 1084 | 1054 |
| 4.0 | 92 | 136 | 105 |
| 6.8 | 107 | 312 | 211 |
| 11.5 | 110 | 558 | 421 |

TABLE IV

| | | | Silver Feed Ratio |
|---|---|---|---|
| Targeted | Targeted | | Experimentally |
| Wire | Wire | Silver Feed Ratio | Determined to |
| Length | Diameter | According to | Achieve Targeted |
| (μm) | (nm) | Eqn. (3) | Length and Diameter |
| 14 | 126 | 833 | 1054 |
| 19.1 | 119 | 1073 | 1054 |
| 4.0 | 92 | 174 | 105 |
| 6.8 | 107 | 343 | 211 |
| 11.5 | 110 | 597 | 421 |

What is claimed:

1. A method comprising:
selecting at least one product geometrical parameter;
providing at least one first composition comprising a first amount of at least one first reducible metal ion;
providing at least one second composition comprising a second amount of the at least one first metal or metal ion; and
reducing at least some of the first amount of the at least one first reducible metal to at least one first metal in the presence of the second amount of the at least one first metal or metal ion,
wherein the ratio of the second amount to the first amount is specified based upon the at least one product geometrical parameter.

2. The method according to claim 1, wherein the at least one product geometrical parameter comprises one or more of a product length, a product diameter, a product volume, or a product surface area.

3. The method according to claim 2, wherein the ratio of the second amount to the first amount is selected to be a function of the product length.

4. The method according to claim 2, wherein the ratio of the second amount to the first amount is selected to be a function of the product diameter.

5. The method according to claim 2, wherein the ratio of the second amount to the first amount is selected to be a function of the product length multiplied by the product diameter.

6. The method according to claim 2, wherein the ratio of the second amount to the first amount is selected to be a function of the product length multiplied by the square of the product diameter.

7. The method according to claim 2, wherein the ratio of the second amount to the first amount is selected to be a function of the product volume.

8. The method according to claim 1, wherein the at least one first reducible metal ion comprises a silver ion.

9. At least one nanowire comprising the first metal product formed according to the method of claim 1.
